(19) United States
(12) Patent Application Publication
(10) Pub. No.: US 2021/0187891 A1
(43) Pub. Date: Jun. 24, 2021

(54) METHOD FOR MAKING A PLASTIC BAG

(71) Applicant: Totani Corporation, Kyoto (JP)

(72) Inventor: Mikio TOTANI, Kyoto (JP)

(73) Assignee: Totani Corporation, Kyoto (JP)

(21) Appl. No.: 16/770,949

(22) PCT Filed: Nov. 8, 2018
(86) PCT No.: PCT/JP2018/041445

§ 371 Date: Jun. 9, 2020

(30) Foreign Application Priority Data
Dec. 19, 2017 (JP) 2017-242832

(51) Int. Cl. B31B 70/16; B31B 70/74; B31B 70/64; B31B 70/98

(52) U.S. Cl. CPC B31B 70/16; B31B 70/76; B31B 2150/002; B31B 70/98; B31B 70/64

(57) ABSTRACT

A plastic bag includes a sealed region. The sealed region is formed along part or whole of an edge of the plastic bag by a section in which at least two plastic films are sealed to each other. The edge of the plastic bag includes a sealed edge of the sealed region. A method for making the plastic bag includes heat-sealing the films to each other to form the sealed region. The method further includes cutting the films such that part or whole of the sealed edge is formed by a cut edge. The method further includes heating an area formed by the cut edge of the sealed edge to smooth the area.

### TECHNICAL FIELD

The present invention relates to a method for making a plastic bag.

### BACKGROUND ART

A plastic bag includes a sealed region formed along whole or part of its edge so as to ensure its sealability.

A method for making such a plastic bag is disclosed, for example, in Patent documents 1-3. For example, the method superposes at least two films on each other. The method then heat-seals the films to each other to form a sealed region. The method then cuts the films by unit of the bag with a cutter, thereby making the plastic bag. In this step, the films are cut along the sealed region, and thereby an edge of the sealed region of the plastic bag is formed by a cut edge resulting from the cutting.

Cutting the films along the sealed region using a sharp edged tool such as a cutter results in the sealed region having a very sharp cut edge. Due to this, when the plastic bag is shifted to a hand holding the plastic bag, the cut edge of the sealed region may hurt the hand. Like this, there is a danger that the cut edge of the sealed region may hurt, for example, a hand.

### CITATION LIST

### Patent Document

[Patent Document 1] Japanese Unexamined Patent Application Publication No. 2011-020719
[Patent Document 2] Japanese Unexamined Patent Application Publication No. H11-320708
[Patent Document 3] Japanese Patent Publication No. 3733085

### PROBLEM TO BE SOLVED BY THE INVENTION

An object of an aspect of the present invention is to provide a method for making a plastic bag with increased safety.

### SUMMARY OF THE INVENTION

According to an aspect of the present invention, there is provided a method for making a plastic bag having an edge. The plastic bag includes a sealed region. The sealed region is formed along part or whole of the edge of the plastic bag by a section in which at least two plastic films are sealed to each other. The edge of the plastic bag includes a sealed edge of the sealed region. The method includes: heat-sealing the films to each other to form the sealed region; cutting the films such that part or whole of the sealed edge is formed by a cut edge; and heating an area formed by the cut edge of the sealed edge to smooth the area.

The method may include, while conveying a plurality of plastic bags in a state that the plastic bags are stacked with each other, heating the area of each of the plastic bags to smooth the area.

The method may include heating the area to smooth the area while cooling an intermediate part of the plastic bag.

The sealed edge may include a sealed corner edge part of the plastic bag. In the method, the sealed corner edge part may be formed by the cut edge, and the sealed corner edge part may be heated to be smoothed.

The sealed edge may include a sealed side edge part of the plastic bag. In the method, the sealed side edge part may be formed by the cut edge, and the sealed side edge part may be heated to be smoothed.

The sealed edge may include a sealed side edge part of the plastic bag. In the method, a gusset and two sheet panels may be used as the films. The method may further include interposing the folded or bent gusset between the sheet panels. The method may include: heat-sealing the sheet panels and the gusset to each other to form the sealed region; cutting the sheet panels and the gusset at a position of the sealed region such that the sealed side edge part is formed by the cut edge; and heating the sealed side edge part to smooth the sealed side edge part.

In the method, a side gusset or bottom gusset may be used as the gusset.

### BRIEF DESCRIPTION OF DRAWINGS

FIG. 1 is a front view of a plastic bag according to an implementation.

FIG. 2 is a side view schematically illustrating an example of an apparatus for making plastic bags.

FIG. 3 describes a making method according to an implementation of the present invention.

FIG. 4 illustrates a tip part of a punch blade.

FIG. 5 describes smoothing of a sealed edge (cut edge).

FIG. 6 describes an example of a smoothing step.

FIG. 7A is a plan view schematically illustrating an example of a smoothing device, and FIG. 7B is a partial sectional side view of the device of FIG. 7A.

FIG. 8 is a partial sectional side view illustrating another example of the smoothing device.

FIG. 9 illustrates another arrangement of the device of FIG. 7A.

FIG. 10 is a front view of a plastic bag according to an implementation.

FIG. 11A is a front view of a plastic bag according to another implementation, and FIG. 11B is an enlarged partial sectional view of FIG. 11A.

FIG. 12 describes a making method according to another implementation of the present invention.

### IMPLEMENTATIONS

A method for making a plastic bag according to implementations of the present invention will now be described with reference to the accompanying drawings. In each of the implementations, same or similar elements are indicated by same reference numerals, and the explanation thereof is omitted as much as possible. Elements illustrated in the Figures are not drawn to scale, but only to illustrate operation.

[First Implementation]

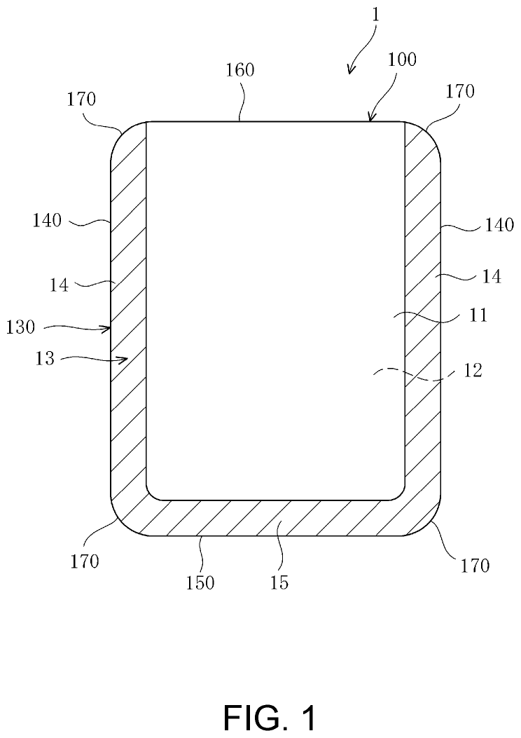

As illustrated in FIG. 1, a plastic bag 1 (hereinafter sometimes simply referred to as “bag”) is made of plastic film. The bag 1 includes films 11 and 12 opposed to each other (hereinafter sometimes referred to as “first sheet panel 11” and “second sheet panel 12”). Each of the films 11 and 12 of the implementation is a plastic film having a laminated structure. Inner surfaces of the films 11 and 12 are made of the sealant such as polyethylene, polypropylene, etc. Outer surfaces of the films 11 and 12 are made of the base such as nylon, PET (polyethylene terephthalate), etc.

The bag 1 includes an edge 100 along its periphery. The edge 100 of the bag 1 includes four side edge parts 140, 150 and 160 each having a linear shape, and four corner edge parts 170 joining the side edge parts 140, 150 and 160 and each having a rounded and protruding shape.

The bag 1 further includes a sealed region 13 formed along part or whole the edge 100. The sealed region 13 is formed by a section in which at least two films are sealed to each other. In the implementation, the sealed region 13 is formed along part of the edge 100. The sealed region 13 includes two sealed parts 14 (hereinafter sometimes referred to as “first sealed parts 14”) formed along two opposite side edge parts 140, and a sealed part 15 (hereinafter sometimes referred to as “second sealed part 15”) formed along one side edge part 150 of the remaining opposite side edge parts 150 and 160. In the implementation, each of the sealed parts 14 and 15 is formed by a section in which the two films 11 and 12 are sealed to each other.

Therefore, the edge 100 of the bag 1 in the implementation includes a sealed edge 130 of the sealed region 13 and the open side edge part 160 (that is, non-sealed side edge part). The sealed edge 130 includes the three sealed side edge parts 140 and 150, and the four sealed corner edge parts 170. The open side edge part 160 is used when filling contents in the bag 1.

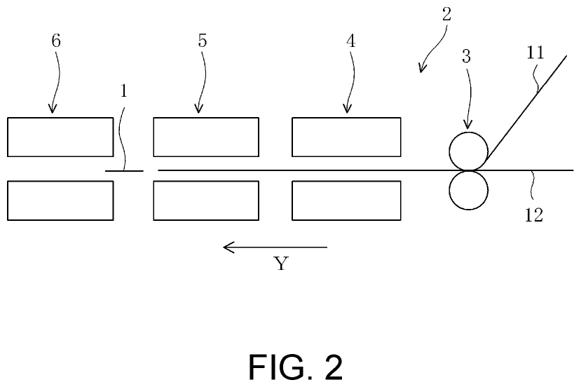

A method for making a plastic bag 1 of FIG. 1 according to an implementation will be described. FIG. 2 illustrates an example of a bag making apparatus 2 for implementing the method. The apparatus 2 includes a feeding device 3, a heat seal device 4 and a cutting device 5. As described below, the cutting device 5 includes a punch blade for forming the corner edge parts 170, a cutter for cutting the films 11 and 12 in a feed direction Y and a cutter for cutting the films 11 and 12 in a direction perpendicular to the feed direction Y.

The two continuous films 11 and 12 (the first and second sheet panels) are intermittently fed with the feeding device 3, that is, being repeatedly fed and paused at predetermined intervals. The films 11 and 12 are superposed on each other with the feeding device 3. The feed direction Y of the continuous films 11 and 12 is the longitudinal (continuous) direction thereof.

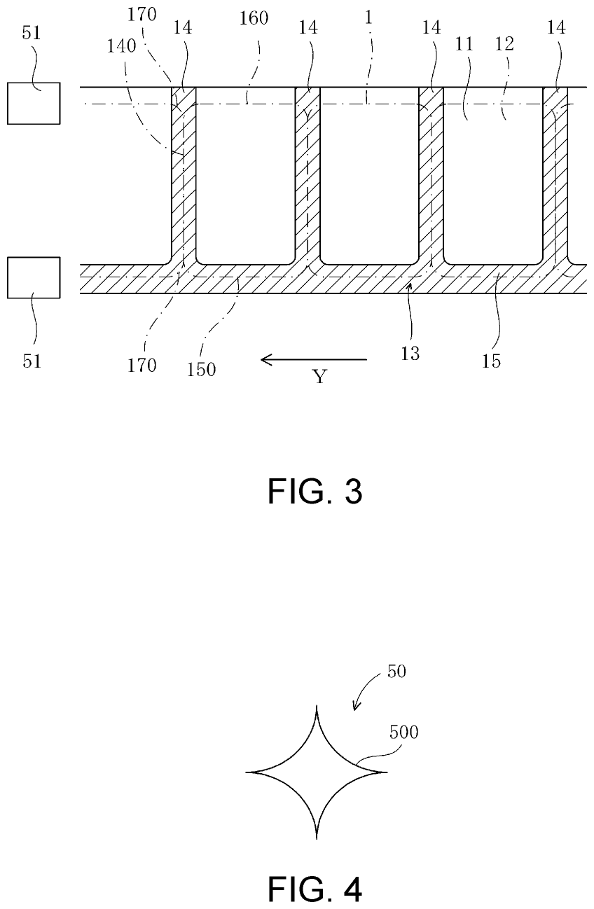

The films 11 and 12 are then heat-sealed to each other with the heat seal device 4 during every pause, and thereby the sealed region 13 is formed as illustrated in FIG. 3. The heat seal device 4 generally includes a longitudinal seal mechanism and a cross seal mechanism. In the implementation, the second sealed part 15 is formed with the longitudinal seal mechanism, and the first sealed part 14 is formed with the cross seal mechanism.

After heat-sealing of the films 11 and 12, the films 11 and 12 are cut with the cutting device 5, and thereby the edge 100 of the bag 1 is formed by the cut edge resulting from the cutting. Thus, the shape of the bag 1 is completed.

As illustrated in FIG. 4, the cutting device 5 of the implementation includes a punch blade 50 and a receiving blade (not shown) for receiving the punch blade 50. A tip part 500 of the punch blade 50 has a shape of the combined four corner edges 170. The receiving blade includes the hole having a shape corresponding to the tip part 500. The punch blade 50 is moved vertically by the driving mechanism (not shown) with respect to the receiving blade, to cut (punch) the films 11 and 12 in conjunction with the receiving blade.

The films 11 and 12 are cut (punched) with the punch blade 50 during every pause, and thereby the sealed corner edges 170 are formed by the cut edge resulting from the cutting.

As illustrated in FIG. 3, the cutting device 5 further includes two cutters 51 for cutting the films 11 and 12 in the feed direction Y. The films 11 and 12 are cut (slit) with one cutter 51 along the second sealed part 15 during every feed, and thereby the sealed side edge part 150 is formed by the cut edge resulting from the cutting.

The films 11 and 12 are cut (slit) with the other cutter 51 in the feed direction Y during every feed, and thereby the open side edge part 160 is formed by the cut edge resulting from the cutting.

The cutting device 5 further includes an additional cutter (not shown) for cutting the continuous films 11 and 12 in the width direction thereof (a direction perpendicular to the feed direction Y). This cutter includes, for example, a pair of an upper blade and a lower blade for shearing the films 11 and 12 in a direction perpendicular to the feed direction Y. The films 11 and 12 are cut (sheared) along the first sealed part 14 with the cutter during every pause, and thereby the sealed side edge part 140 is formed by the cut edge resulting from the cutting.

Every time the continuous films 11 and 12 are cut in the width direction thereof along the sealed part 14, the bag 1 is shaped. At least a part (in the implementation, whole) of the sealed edge 130 (FIG. 1) of the sealed region 13 is formed by the cut edge resulting from the cutting of the films 11 and 12.

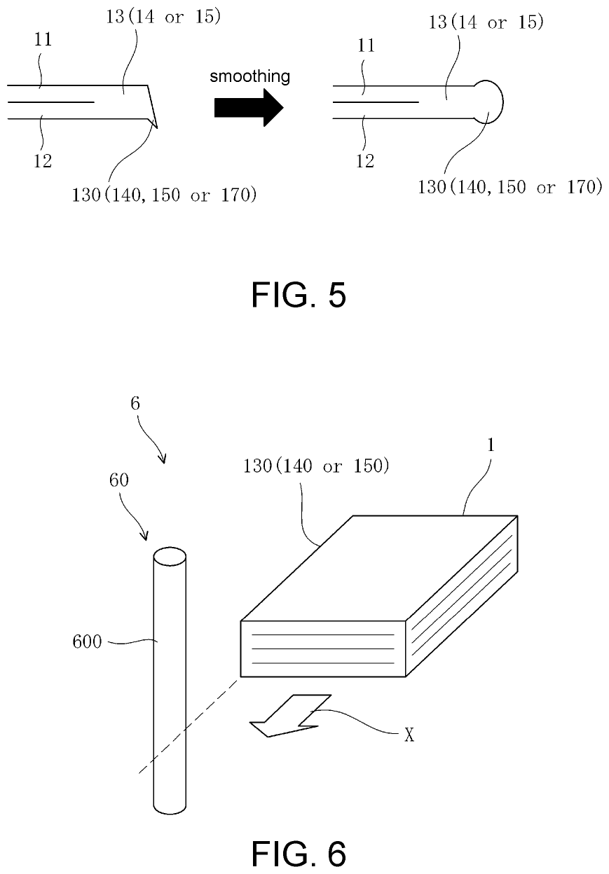

FIG. 5 illustrates a cross section of the sealed region 13 (sealed part 14 or 15) of the bag 1. In the sealed region 13 after passing through the cutting device 5, the films 11 and 12 are integrated with each other due to melting of the sealant. As illustrated in FIG. 5, the sealed edge 130 (140, 150, or 170) is sharp since it is formed by a cut edge resulting from physical cutting with an edged tool such as a cutter. In particular, the sealed side edge part 140 in the implementation is very sharp since it is formed by the cut edge resulting from the shearing. Therefore, there is a risk that the sealed edge 130 may hurt a hand. For this, the apparatus 2 further includes a smoothing device 6 (FIG. 2) disposed downstream of the cutting device 5.

The smoothing device 6, in the implementation, includes a heat unit for heating the sealed edge 130. The heat unit is, for example, a hot air generator. The hot air generator includes a main body configured to generate hot air and a nozzle which is attached to the main body and from which hot air is blown.

The nozzle is preferably attached to the main body in an interchangeable manner. It is, therefore, possible to attach to the main body a nozzle having the optimal shape suitable for the kind of the film or the arrangement of the hot air generator. As a result, the following smoothing step can be performed efficiently.

The bag 1 is conveyed from the cutting device 5 to the smoothing device 6. An area formed by the cut edge, of the sealed edge 130 (in the implementation, whole of the sealed edge 130) is heated to be smoothed with the smoothing device 6. In the implementation, hot air is blown from the nozzle to the sealed edge 130, and thereby the sealed edge 130 is heated to be smoothed with the hot air. In other words, the sealed side edge pasts 140 and 150 and the sealed corner edge parts 170 are heated to be smoothed.

“To smooth” means to eliminate a sharp shape of an object to make it a smooth shape. Therefore, the smoothing step according to an implementation of the present invention is a step of making an area formed by the cut edge of the sealed edge 130 smooth as illustrated in FIG. 5 by heat-melting the area of the sealed edge 130. The same is applied to the following implementations. As a result of the smoothing step, the smooth sealed edge 130 can be formed.

The open side edge part 160 is not included in the sealed region 13. However, the open side edge part 160 may be smoothed, since it is formed by a cut edge.

The condition for smoothing the cut edge differs depending on material of the base and material of the sealant of the laminate films 11 and 12. The tip of the cut edge resulting from the cutting (especially shearing) of the films 11 and 12 is made of the bases of the films 11 and 12. Therefore, smoothing can be achieved by heating the cut edge to a temperature equal to or higher than the melting point of the base. For example, when the base is PET, heating to a temperature equal to or higher than 260° C., which is the melting point of PET, is required for smoothing. When the base is nylon, heating to a temperature equal to or higher than 215° C., which is the melting point of nylon, is required for smoothing.

Since the melting point of the sealant is lower than that of the base, not only the base but also the sealant changes to a molten state during smoothing. However, appropriate adjustment of the heating time and the heating temperature can easily prevent the sealant from melting too deeply. In addition, due to surface tension, the melted sealant can also be easily prevented from flowing out.

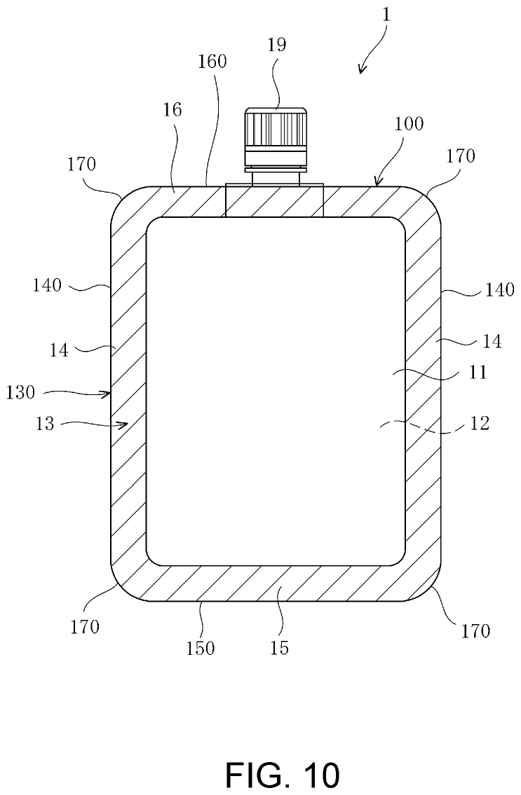

The bag 1 of FIG. 1 is made via the above smoothing step. In a subsequent step, the contents are filled in the bag 1 from the open side edge part 160. After filling, the films 11 and 12 may be heat-sealed to each other along the open side edge part 160, and thereby the sealed part 16 is formed as illustrated in FIG. 10. Thus, the sealed side edge part 160 is formed. In addition to this, a spout 19 may be provided at a position of the sealed part 16.

As described above, there is a high risk that the cut edge may hurt a hand. In the implementation, the area formed by the cut edge of the sealed edge 130 is smoothed by heating. Therefore, even if the plastic bag 1 is shifted to a hand holding the plastic bag 1, the sealed edge 130 does not hurt the hand. The safety of the plastic bag 1 is very high.

After the smoothing step, a cooling step of cooling the area formed by the cut edge of the sealed edge 130 and its surrounding part with air may be performed. This improves the quality of smoothing. For example, air is applied to the both surfaces of the bag 1 to cool the area formed by the cut edge of the sealed area 130 and its surrounding part. Using air cooled with a refrigerant, for example, enhances the effect.

[Second Implementation]

This implementation, while conveying a plurality of the plastic bags 1 stacked with each other, heats the area formed by the cut edge of the sealed edge 13 of each bag 1 to smooth the area using the smoothing device 6.

The smoothing device 6 of the implementation is configured to heat the sealed edge 130 not with hot air but with thermal radiation. As illustrated in FIG. 6, the heat unit 60 of the smoothing device 6 includes a heater instead of the hot air generator. The heater includes a heat source 600 such as an infrared light source. The heat source 600 is, for example, a halogen lamp. In this implementation, the heat source 600 has a longitudinal direction and is oriented perpendicular to the conveyance direction X of the bag 1. The heat source 600 may be oriented in the conveyance direction X of the bag 1.

The bag 1 is shaped with the cutting device 5 as in the first implementation. Subsequently, a certain number of the bags 1 are stacked with each other. The stacked bags 1 are then conveyed in the direction X with a conveyor (not shown) to pass adjacent to the heat unit 60 at an appropriate speed. While the stacked bags 1 are passing adjacent to the heat unit 60, the sealed edge 130 (that is, the sealed side edge part 140 or 150) of each bag 1 is heat-melted with the heat unit 60 to a temperature equal to or higher than the melting point of the material of the films 11 and 12, and thereby smoothed.

The conveyance speed of the bag 1 affects heat-smoothing. If the conveyance speed is fast, increasing the heat energy to the cut edge enables heating the cut edge to a temperature equal to or higher than the melting point of the base to smooth the cut edge. The heat energy of the above-described hot air generator or heater can easily be adjusted. Therefore, it is possible to appropriately smooth the cut edge while conveying the bag 1, by adjusting the heat energy to the cut edge and the conveyance speed of the bag 1 in consideration of the melting point of the material of the film.

[Third Implementation]

This implementation heats the area formed by the cut edge of the sealed edge to smooth the area while cooling an intermediate part of the bag 1.

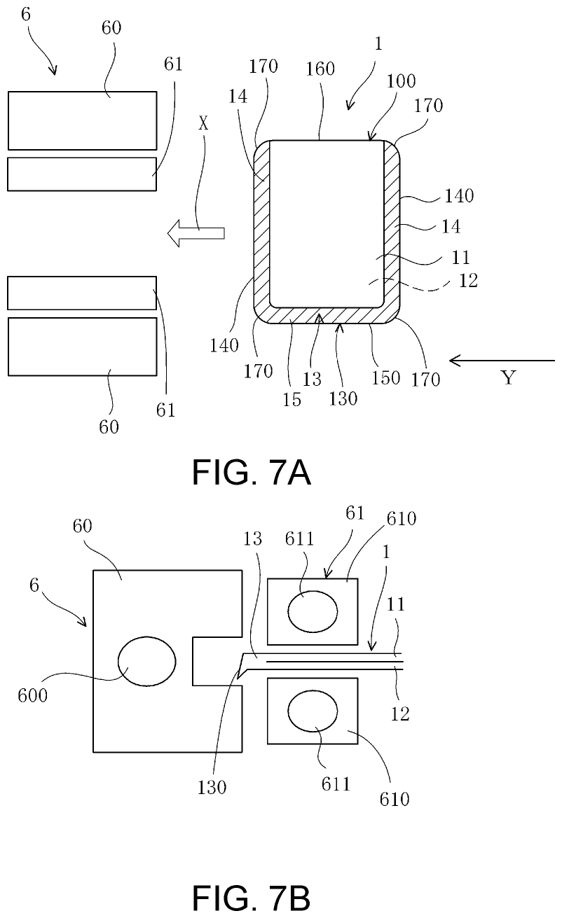

As illustrated in FIG. 7A, the smoothing device 6 of the implementation includes two heat units 60 disposed to be opposed to each other in a direction perpendicular to the conveyance direction X of the bag 1. FIG. 7B schematically illustrates one heat unit 60 viewed from the direction of the arrow Y in FIG. 7A. In the implementation, each of the heat units 60 is a heater including a heat source 600. Alternatively, the heat unit 60 may be a hot air generator. The heat units 60 are disposed such that each of them is opposed to any one of the side edge parts 140, 150, 160 of the bag 1 while the bag 1 is passing through the smoothing device 6.

The smoothing device 6 further includes cool units 61 provided for each of the heat units 60 and configured to cool an intermediate part of the bag 1. The cool units 61 are disposed near the corresponding heat unit 60. The cool units 61 are disposed such that they are opposed to an intermediate part of the bag 1 while the bag 1 is passing through the smoothing device 6.

Each of the cool units 61 includes two coolers 610 opposed to each other. The coolers 610 are disposed such that the bag 1 passes between the coolers 610 and that the coolers 610 are opposed to an intermediate part of the bag 1 while the bag 1 is passing. Each of the coolers 610 has a passage 611 through which the refrigerant passes. The passage 611 extends in the conveyance direction X of the bag 1.

After the bag 1 is shaped with the cutting device 5, the bag 1 is conveyed with a conveyor (not shown) to the smoothing device 6. When the bag 1 is conveyed through the smoothing device 6 as illustrated in FIG. 7A, the heat units 60 heat the sealed side edge part 150 and the non-seal side edge part 160 of the bag 1 to smooth the edge parts 150 and 160. At the same time, the cool units 61 cool the both surfaces of the intermediate part of the bag 1. In particular, the cool units 61 efficiently cool regions close to the side edge parts 150 and 160.

Therefore, the area formed by the cut edge of the seal edge part 130 is smoothed with the heat units 60 while the intermediate part of the bag 1 is cooled with the cool units 61. This enables preventing a region except the edge 100 of the bag 1 (namely, the intermediate part of a bag) from scorching due to heat.

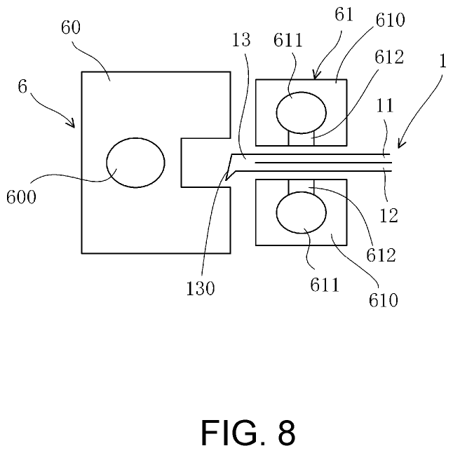

Gas may be used as the refrigerant, and the intermediate part of the plastic bag 1 may be cooled by spraying the gas directly on the intermediate part. For this, the smoothing device 6 in FIG. 8 uses cooled air as the refrigerant gas. Each of the coolers 610 has at least one blowout hole 612 extending from the refrigerant passage 611. In the implementation, a plurality of blowout holes 612 is arranged side by side in the conveyance direction X (FIG. 7A) of the bag 1. Air is blown out from each blowout hole 612 through the passage 611, applied to the intermediate part of the bag 1 while the bag 1 is passing through the smoothing device 6, and thereby the intermediate part is cooled with air.

The smoothing device 6 is disposed downstream of and next to the cutting device 5, and the conveyance direction X of the bag 1 is parallel to the feed direction Y of the continuous films 11 and 12. Therefore, the side edge parts 150 and 160 are smoothed, whereas both of the sealed side edge parts 140 are not smoothed.

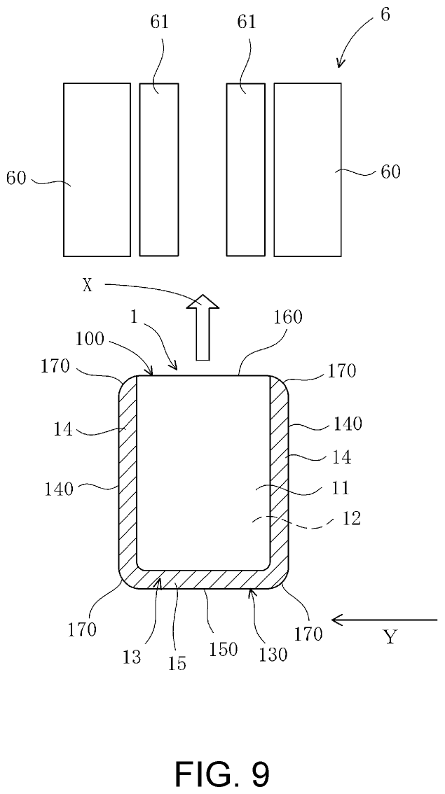

In order to smooth both of the sealed side edge parts 140, as illustrated in FIG. 9, the conveyance direction X of the bag 1 may be turned 90 degrees from the feed direction Y with a conveyor disposed downstream of the cutting device 5, and then the bag 1 may pass through the smoothing device 6. Thereby, both of the sealed side edges 140 are heated to be smoothed with the smoothing device 6.

Instead of the above, for example, only one heat unit 60 may be disposed such that it is opposed to one side edge part to be smoothed while the plastic bag 1 is being conveyed.

[Fourth Implementation]

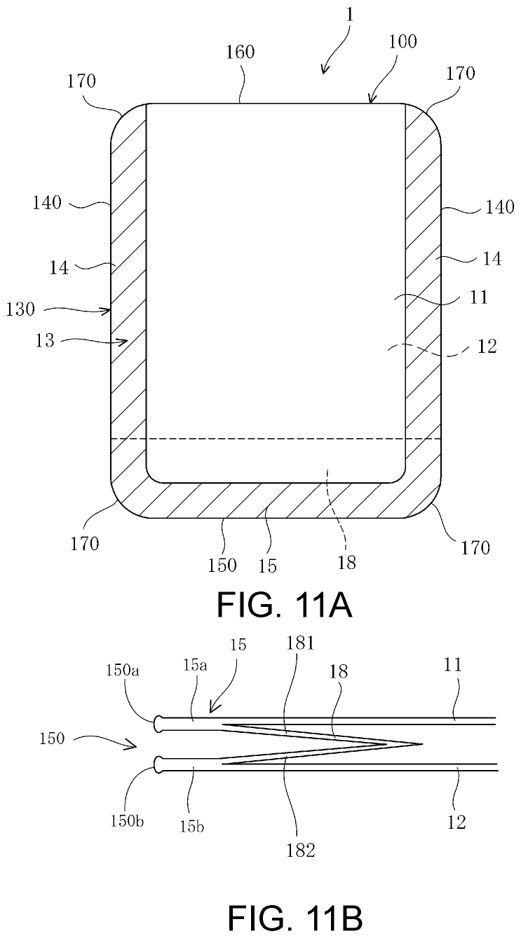

This implementation makes a bag 1 of FIG. 11A. The bag 1 further includes, as an additional film, at least one gusset 18 for increasing the capacity of the bag 1. The gusset 18 of the implementation is a bottom gusset. The gusset 18 is folded in half, interposed between the films 11 and 12, and extends along the sealed side edge part 150 of the bag 1.

As illustrated in FIG. 11B, the sealed part 15 includes a first sealed portion 15a formed by a section in which the first sheet panel 11 and one side part 181 of the gusset 18 are sealed to each other, and the second sealed portion 15b formed by a section in which the second sheet panel 12 and the other side edge 182 of the gusset 18 are sealed to each other. Accordingly, the sealed side edge part 150 includes the first edge portion 150a of the first sealed portion 15a and the second edge portion 150b of the second sealed portion 15b.

The gusset 18 of the implementation is a plastic film having a laminated structure same as those of the sheet panels 11 and 12. The inner surface (that is, the surface facing the sheet panel) of the gusset 18 is made of the sealant, whereas the outer surface of the gusset 18 is made of the base.

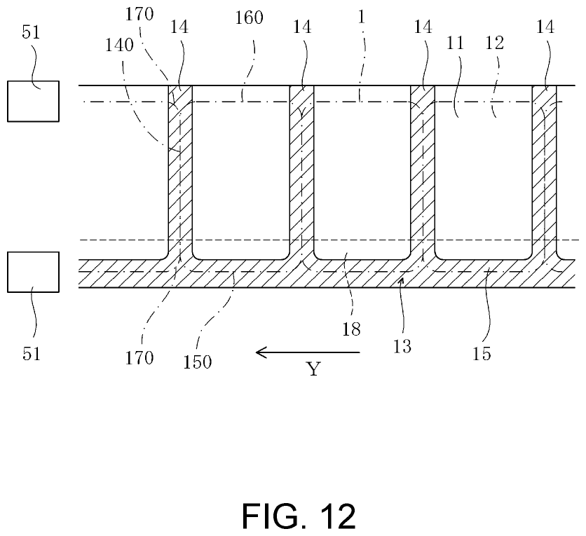

For example, a continuous gusset 18 is used as illustrated in FIG. 12. The gusset 18 in a folded state is supplied with a gusset supplying mechanism (not shown) to the continuous first and second sheet panels 11 and 12. The gusset 18 is then interposed between the first and second sheet panels 11 and 12 when the first and second sheet panels 11 and 12 are superposed on each other with a feeding device 3 (FIG. 2). At this time, the gusset 18 is positioned along one side of the continuous first and second sheet panels 11 and 12.

Subsequently, the first and second sheet panels 11 and 12 and the gusset 18 are heat-sealed with the heat-seal device 4 (FIG. 2), and thereby the sealed region 13 is formed. In this step, the first and second sheet panels 11 and 12 and the gusset 18 are heat-sealed to each other with the longitudinal seal mechanism, and thereby the sealed part 15 is formed. In other words, the first sheet panel 11 and the one side part 181 are heat-sealed to each other, and thereby the first sealed portion 15a is formed. Furthermore, the second sheet panel 12 and the other side part 182 are heat-sealed to each other, and thereby the second sealed portion 15b is formed.

Subsequently, the first and second sheet panels 11 and 12 and the gusset 18 are cut with the cutting device 5 (FIG. 2), and thereby the bag 1 is shaped. In this step, the first and second sheet panels 11 and 12 and the gusset 18 are cut along the sealed part 15 with one cutter 51, and thereby the sealed side edge portion 150 is formed by the cut edge resulting from the cutting. In other words, each of the first and second edge portions 150a and 150b is formed by the cut edge.

Subsequently, the sealed edge 13 is heated to be smoothed with the smoothing device 6. In this step, the first and second edge portions 150a and 150b are heated to be smoothed. Thus, the bag 1 of FIG. 11 is made. Thereafter, a filling step may be performed as in the other implementations.

When the first and second sheet panels 11 and 12 and the gusset 18 are cut, strong crimping force is added to these films. As a result, the first and second edge portions 150a and 150b can adhere to each other. This is referred to as “blocking”.

The folded gusset 18 always has restoring stress which is exerted in a direction of folding back. Since the blocked first and second edge portions 150a and 150b are melted due to heat when being heated to be smoothed, they disengage with each other due to the stress. Thus, the blocking can be eliminated at the same time of smoothing.

The blocking is conventionally and typically eliminated by using the expansion of the bag in accordance with the filling of the contents. However, in the case where the blocking is strong, it can fail to be eliminated even if the bag is filled with contents. As a result, the bag can fail to be filled with contents due to the failure of the expansion of the bag. Thus, it is very advantageous to be able to eliminate the blocking by using the heat during smoothing as described above.

Although the bottom gusset is exemplified as the gusset 18, the gusset 18 may be a side gusset provided along the sealed side edge part 140. Instead of the folded gusset 18, a bent gusset 18 may be used. In this case, the blocking can also be eliminated during smoothing, since the restoring stress is exerted on the gusset 18.

If too many bags 1 are stacked, the weight of the stacked bags 1 exceeds the restoring stress of the gusset 18. Consequently, when the stacked bags 1 are subjected to a smoothing process all at once, the blocking may not be eliminated. Therefore, the number of bags 1 to be stacked should be adjusted as appropriate.

Although the preferred implementations according to the present invention are described, the present invention is not limited to the above implementations.

In the above implementations, the bag 1 is shaped every time the continuous films 11 and 12 are cut in the width direction thereof. More than two bags 1 may be shaped every time the continuous films 11 and 12 are cut in the width direction thereof. Even in this case, the cut edge of each bag 1 can be smoothed if the heat units 60 are appropriately disposed.

The sealed region 13 may have a section in which more than three films are stacked with and sealed to each other. In this case, since the rigidity of the sealed edge 130 is high, it is very advantageous to smooth the sealed edge 130.

A bag other than ones illustrated in the implementations (for example, a plastic bag with a chuck) may be made.

### EXPLANATIONS OF LETTERS OR NUMERALS

1 plastic bag

100 edge of the plastic bag

11 film (first sheet panel)

12 film (second sheet panel)

13 sealed region

130 sealed edge

14 sealed part

140 sealed side edge part

15 sealed part

150 sealed side edge part

160 open side edge part

170 sealed corner edge part

18 film (gusset)

6 smoothing device

60 heat unit

600 heat source

61 cool unit

610 cooler

611 passage for refrigerant

612 blowout hole for refrigerant gas

X conveyance direction of the plastic bag

Y feed direction of the continuous film

1. A method for making a plastic bag having an edge, the plastic bag comprising:
a sealed region formed along part or whole of the edge by a section in which at least two plastic films are sealed to each other, the edge of the plastic bag comprising a sealed edge of the sealed region,
the method comprising:
heat-sealing the films to each other to form the sealed region;
cutting the films such that part or whole of the sealed edge is formed by a cut edge; and
heating an area formed by the cut edge of the sealed edge to smooth the area.

2. The method according to claim 1, comprising, while conveying a plurality of plastic bags in a state that the plastic bags are stacked with each other, heating the area of each of the plastic bags to smooth the area.

3. The method according to claim 1, comprising heating the area to smooth the area while cooling an intermediate part of the plastic bag.

4. The method according to claim 1, wherein the sealed edge comprising a sealed corner edge part of the plastic bag,
wherein the sealed corner edge part is formed by the cut edge, and
wherein the sealed corner edge part is heated to be smoothed.

5. The method according to claim 1, wherein the sealed edge comprising a sealed side edge part of the plastic bag,
wherein the sealed side edge part is formed by the cut edge, and
wherein the sealed side edge part is heated to be smoothed.

6. The method according to claim 1, wherein the sealed edge comprising a sealed side edge part of the plastic bag, and
wherein a gusset and two sheet panels are used as the films,
the method further comprising interposing the folded or bent gusset between the sheet panels,
the method comprising:
heat-sealing the sheet panels and the gusset to each other to form the sealed region;
cutting the sheet panels and the gusset at a position of the sealed region such that the sealed side edge part is formed by the cut edge; and
heating the sealed side edge part to smooth the sealed side edge part.

7. The method according to claim 6, wherein a side gusset or bottom gusset is used as the gusset.
